(19) United States
(12) Patent Application Publication
(10) Pub. No.: US 2005/0043416 A1
(43) Pub. Date: Feb. 24, 2005

(54) Method for dispersing fog and/or clouds

(76) Inventor: Detlev Möller, Berlin (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/484,792

(22) PCT Filed: Jul. 24, 2002
(86) PCT No.: PCT/EP02/08266

(30) Foreign Application Priority Data
Jul. 25, 2001 (DE) 101 35 400.2

(51) Int. Cl. C09K 3/24

(52) U.S. Cl. 516/114

(57) ABSTRACT

The invention relates to a method for dispersing fog and/or clouds. The aim of the invention is to develop a method, by means of which the dispersion of fog and/or the generation of precipitation from clouds may be rapidly and efficiently carried out in an environmentally-friendly manner. Said aim is achieved, whereby ice particles (solid H₂O) are applied to the fog and/or the cloud with an initial speed of between ca 10 m/s and ca. 300 m/s, preferably between ca 100 m/s and ca. 200 m/s, whereby the ON particle size is chosen to be larger than the droplet size, thus causing dispersion of the fog and/or a precipitation from the cloud.

The invention relates to a method for dispersing fog and/or clouds for producing precipitation, preferably at temperatures above 0° C. according to the preamble of claim 1.

Fields of use are preferably the dispersion at fog at airports and roads, but also at production facilities, open-air and sports events, as well as use in defense technology, producing rainfall from clouds for agricultural purposes and for supplying drinking water.

Fog poses a tremendous economical burden and safety risk for air, road and boat traffic due to the restricted visibility. In spite of the availability of quite sophisticated locating equipment, for example satellite navigation, radio navigation and special illumination devices. It is difficult estimate the costs caused by traffic cancellations, traffic delays and necessary changes in the traffic flow, not to mention accidents, which amount worldwide to almost EUR 1 billion annually. In addition, accidents can cause severe injuries and even death. Air traffic is estimated to increase by about 25% over the next five to ten years. Delays in the landing frequency of up to 50% may have to be accepted in spite of modern locating systems, even under category I-CAO II and III weather conditions. Models for forecasting fog adapted to local conditions are being developed worldwide in order to be able to operate in foggy conditions. Accordingly, there is an urgent need for an effective method to disperse fog.

Fog interferes with open air and sports events, such as winter sports competition, in particular ski racing and ski jumping, stadium events, in particular soccer games. Events are frequently canceled or delayed due to poor visibility for athletes, referees, spectators and the TV audience. If events take place in spite of poor visibility, safety and athletic performance can be impaired. The loss of television and advertising revenue can lead to economic shortfalls.

In addition, fog at construction sites and production facilities, for example in open pit mining, can cause production and revenue losses.

For the above reasons, there is a great economical and safety interest in methods that can quickly and effectively disperse fog.

A statistical analysis of the occurrence of fog shows that most frequently warm fog occurs (T>0° C.), which requires somewhat different physical concepts for dispersion than cold fog (T<0° C.).

Many regions on earth have a low yearly rainfall. In particular, if these regions are density populated, the rainfall is insufficient for supplying enough drinking water and for operating an effective agriculture business. Accordingly, there is a great economical and vital interest in methods that can intentionally generate rainfall from clouds.

Also, since local drinking water resources become increasingly scarce, there is worldwide an urgent need for a technology that produces drinking water.

DE 100 05 898 A1 describes a thus far unexploited concept—referred to as nucleation collision—for dispersing cold fog by employing dry ice jets, that is capable of efficiently, i.e. rapidly and cost-effectively, remove cold fog.

However, this method is unsuitable for removing warm fog because, on one hand, the dry ice particles injected into the fog evaporate very quickly and, on the other hand, a large number of additional droplets are formed at T>0° C. due to local undercooling (lowering of the dew point), which actually intensifies the fog.

Warm fog cannot be dispersed by condensation growth of the droplets, i.e. by local freezing.

The only physical concepts known to date rely on evaporating droplets, for example, by heating the foggy air or mixing the air with undersaturated air that is primarily drawn from surrounding fog-free areas, by dispersing the fog droplets (for example by using mechanical principles or chemical reactions), and/or by forcing the droplets to grow in size (coalescence), so that the droplets—after reaching a certain size—then deposit on the ground through sedimentation (rainfall).

One of the oldest patents taking advantage of these concepts is directed to noise makers, weather cannons and rockets which attempt to prevent the formation or thunderstorms and hail through a pressure transient introduced in the cloud after the explosion (DE 10 17 06).

All methods known to date could not be moved out of the laboratory and applied in practice due to their low efficiency, their use of environmentally harmful chemical substances or the huge capital and/or operating costs.

Already in the '40s, warm fog has been successfully dispersed at London airports using burners (that burned thousands of tons of oil each day). These experiments were continued in many countries into the '60s using surplus aircraft engines. These methods were not successful due to their high cost and the harm done to the environment.

A thermo-kinetic method has also been proposed (A. A. Chemiikov, M. N. Khaikine and B. Pani: “Form Fog Dispersal on the Highway Venice-Trieste using Electric Precipitators”, 2^{nd} Int. Conference on Fog and Fog Collection, St. John's (Canada) Jul. 15-20, 2000), whereby warm fog is dispersed by carefully heating the air by only approximately 5-10° C. using burners and fans, both housed in a standard container on a vehicle.

Droplet growth in warm fog can be achieved by accelerating the coalescence (H.-R. Pruppacher and D. Klett. Microphysics of clouds and precipitation. D. Reidel Publ. Comp., Dordrecht, 1978), through collision and coalescence of small droplets, through electrostatically charging the droplets and changing the surface properties of the droplets by different methods, e.g. by an electrical discharge, by introducing ions and poly-electrolytes and/or special water-soluble polymers.

These methods also have a low efficiency, since they are too slow in practice for dispersing fog or for generating precipitation from clouds.

A long-known concept whereby droplets are electrostatically charged, resulting in an accelerated droplet growth, has also been employed. The latter method can only operate in stationary settings, so that only a small area can be treated. In addition, using a high voltage requires certain safety precautions (A. A. Chemikov, M. N. Khaikine and B. Pani: “Form Fog Dispersal at the Highway Venice-Trieste using Electric Precipitators”, 2^{nd} Int. Conference on Fog and Fog Collection, St. John's (Canada) Jul. 15-20, 2000).

Charging of droplets was already proposed in 1922 (DE 381217), whereby an accelerated droplet aggregation was to be achieved by introducing the charge directly or through charged partides (DE 83 46 13).

The relative humidity of the air can be lowered by several methods, until it is below the situation vapor pressure. For example, lowering the relative humidity can be accomplished by introducing hygroscopic substances (DE 48 84 79), by directly heating the foggy air, for example with burners. Infrared radiators, heated landing strips or roads, with a blowers, in general by using hot gas jets, but also by forced mixing of the foggy air with the surrounding undersaturated fog-free air with blowers and fans, turbine engines, or by using the intrinsic heat of a vehicle or by employing dryers. The aforedescribed methods consume large amounts of energy, i.e., have high operating costs, take up a lot of space and require technically complex equipment, i.e. a high capital investment.

Methods for directly dispersing fog droplets are based on a mechanical concept, for example the use of droplet separators, or an electrostatic concept or operate with chemical reactions, whereby the substances to be introduced, such as metal carbides, react with the water droplets and convert the droplets into gaseous reaction products. The aforementioned methods also have high costs, a low efficiency and can harm the environment. In principle, all methods that add chemicals to the main constituents of the air, can be regarded as being harmful to the environment. Disadvantageously, with many of these methods, the substances are applied form airplanes flying above the fog or the cloud roiling. This requires that airplanes are able to take off. For this reason, these methods are not particularly suited for dispersing fog at airports.

It has also been attempted to precipitate rainfall from clouds (or fog) by introducing water, during the warmer season between the 0° C. and +5° C., and during the colder season in the form of boiling water (DE 57 86 04).

DE 43 19 850 A1 describes solutions which attempt to disperse the fog by spraying liquid water from nozzles, which causes collisions between the sprayed water and the fog droplets. Sizeable stationery facilities were proposed which are expensive to install and also use large quantities of water.

In summary, it can be said that all methods known to date to have at least one of the following disadvantages, and sometimes a combination of several disadvantages:
low efficiency and/or slowness of the process,
harming the environment mostly through use of toxic substances, and
high investment and/or operating costs.

It is therefore an object of the invention to provide a method for dispersing in particular warm fog and/or produce precipitation from clouds quickly, efficiently and in an environmentally friendly manner.

The object is solved by the characterizing features of claim 1. The invention is characterized in that water lee particles (solid H₂O) are introduced into the fog and/or the cloud with an initial velocity of between approximately 10 m/s and approximately 300 m/s, preferably between approximately 100 m/s and approximately 200 m/s, whereby the particle diameter is selected to be greater than the droplet diameter.

The introduced solid water ice particles collide with a large number of water droplets. This effect is referred to as collision mechanism (G. Sumner, Precipitation: Process and Analysis. 1988. J. Wiley & Sons, 455 pp.).

Solid water has a temperature of ≦0° C. and agglomerates with the fog droplets. If the air temperature is below 0° C. (cold or undercooled fog/cloud), then the fog droplets freeze (formation of water ice nuclei), and depending on the ambient temperature, larger water ice crystals can form which accumulate on the ground.

If the temperature is above 0° C. (warm fog/cloud), then melting occurs, producing larger water droplets that precipitate (wet deposition).

Unlike with injection of dry ice particles (these have a temperature of −78° C.) proposed in DE 100 08 898 A1, the water ice particles will exist in the foggy air for a much longer time due to the much smaller temperature difference relative to the ambient temperature. Water ice cannot form ice nuclei in fog>0° C., and consequently also cannot cause condensation growth.

However, the natural seeder-feeder effect known from cloud physics can be exploited for generating precipitation, whereby ice nuclei fail from higher layers into the rain clouds, causing droplet growth based on coalescence through collisions, which finally leads to the formation of precipitation elements (rainfall).

Likewise, during water ice injection into the fog or the cloud, a forced coalescence and a rapid droplet growth occurs, which causes the droplets to produce rainfall and hence also disperse the fog (or from precipitation from clouds). In addition, the pressure transient produced by the injection results in a forced convection which causes the effect to expand to regions outside the direct range of the water ice particles (mixing of foggy air with already defogged air and therefore additional defogging).

The method has the following advantages as compared to the aforedescribed methods:

1. The water ice particles do not leave any residues harmful to the environment which can accumulate in the water or in the ground.

2. The water ice particles cannot only be introduced into the fog or the cloud from above, but also from the ground by using an air or gas stream which can be produced, for example, with a compressor. Due to the mass of the particles, the impulse transferred by the air flow to the water ice particles is sufficiently large to launch the particles several 10 meters vertically or horizontally into the fog or the cloud.

3. The process for dispersing fog or forming precipitation from clouds is extraordinarily fast i.e., the process occurs within several minutes and is effective with both cold and warm fog.

4. The methods can also been used in a mobile setting, so that they can be applied in traffic management, such as landing strips, roads and harbors, as well as opening air and sports events, without high investment and operating costs.

The efficiency of this method can be increased by surrounding or mixing the water ice particles with additional chemical substances, which support the dispersion of fog or the formation of precipitation from clouds. The chemical substances have the effect of promoting the formation of condensation nuclei or the evaporation of the droplets due to the undersaturation achieved by condensation. In addition, the water ice particles can be surrounded or mixed with additional substances that retard the sublimation process of the water ice and thereby increase the range of the water ice particles.

Additional advantageous embodiments of the invention are recited in the dependent claims.

In the following, respective embodiments are described for both fog dispersion and for producing precipitation from clouds.

For dispersing fog, a screw compressor is installed on a vehicle and provided with a jet nozzle that points vertically upwardly.

Water ice is either crushed in a special ice crusher starting with commercially available ice blocks or supplied as already crushed ice. The crushed ice is fed to the compressed air flow from a feed container over a rotating plate in a metering system, and further crushed to a size between 0.5 and 5 mm before the air jet exist the jet nozzle.

The water ice particles are accelerated by the air jet in the jet nozzle to an initial velocity of approximately 200 m/s.

The vehicle then moves slowly through the fog field and blows the water ice particles into the fog.

With the aforedescribed processes, the fog is dispersed within several minutes.

With cold fog (−4° C.), water ice crystals that are visible to the naked eye are formed which quickly settle to the ground.

The additional ice deposit does not substantially change the ground conditions, because this type of fog is already associated with ground frost and white frost.

For warm fog (+6° C.), the visibility increases rapidly due to the increased droplet size, and it wig start to rain (drizzle). The amount of water precipitated from a 20 m vertical fog layer is only 5-15 g/m², with the amount of introduced water ice being less than 1 g/m³ of the foggy air (for comparison: naturally occurring drizzle contains 100-200 g/m²h).

The water ice can also be produced directly in the facility instead of being stored in a storage container. Water (up to one m³) is kept in an insulated water container at a temperature between +1 to +10° C. preferably at +4° C. A plurality of valve-controlled droplet outlet channels distributes the water over the ground surface in the form of a droplet chain, with the droplets dropping into a refrigerated funnel-shaped space, thereby freezing the droplets (with an optionally controlled size). A rotating scraper prevents the droplets from sticking to the walls. The produced ice particles fall into the tapered section of the container and are subsequently fed into the air jet by a metering device. Dry ice pellets can also be added to the so produced ice particles for further lowering the temperature and, on the other hand, preventing the water ice from sticking.

For dispersing clouds and generating precipitation, a compact ice jet facility is installed in a small airplane (e.g. an airplane for agricultural uses), including a water ice tank, with the jet mounted on the tail of the airplane pointing downwardly. The airplane flies on top of the cloud in the moving direction of the air mass at a minimum speed (e.g., approximately 120 km/h) and blows the water ice particles into the cloud. Depending on the sire of the cloud, meander patterns can be flown to generate precipitation over a larger area. Larger droplets are fanned within several minutes which then cause precipitation (seeder-feeder effect).

1. Method for dispersing fog and/or for forming precipitation from clouds by using water ice, characterized in that the water ice particles (solid H₂O) are introduced into the fbg and/or the cloud with an initial velocity of between approximately 10 m/s and approximately 300 m/s, preferably between approximately 100 m/s and approximately 200 m/s, whereby the particle diameter is selected to be greater than the droplet diameter.

2. Method acing to claim 1, characterized in that the water ice particles are surrounded and/or mixed with additional chemical substances that aid in the dispersion of the fog and/or the formation of precipitation from the cloud.

3. Method according to claim 1, characterized in that the water ice particles are surrounded and/or mixed with additional chemical substances that slow down the sublimation process of the water ice and thereby increase the range of the water ice particles.

4. Method according to the claims 1, characterized in that the water ice particles are introduced into the fog and/or the cloud by an air or gas flow that is generated by a compressor.

5. Method according to the claims 1, characterized in that the water ice particles are introduced into the fog and/or the cloud by an air or gas flow that is provided from a pressurized container.

6. Method according to the claims 1, characterized in that a container containing water ice is caused to burst in the fog and/or in the cloud, thereby introducing the water ice particles into the fog and/or the cloud.

7. Method according to the claims 1, characterized in that the water ice is caused to burst in the fog and/or in the cloud by an explosion and/or a high gas pressure, thereby introducing the water ice particles into the fog and/or the cloud.

8. Method according to the claims 1, characterized in that the water ice particles are introduced into the fog and/or the cloud from a stationary device.

9. Method according to the claims 1, characterized in that the water ice particles are introduced into the fog and/or the cloud from a mobile device.

10. Method according to the claims 1, characterized in that the water ice particles are introduced into the fog and/or the cloud from a ground-based vehicle.

11. Method according to the claims 1, characterized in that the water ice particles are introduced into the fog and/or the cloud from an airplane.

12. Method according to the claims 1, characterized in that the water ice particles are introduced into the fog and/or the cloud from a boat.

13. Method according to the claims 1, characterized in that the water ice particles are introduced into the fog and/or the cloud from a rail vehicle.

14. Method according to the claims 1, characterized in that the water ice particles are introduced into the fog and/or the cloud from a portable device.

15. Method according to claim 1, characterized in that the water ice particles of filled into the device.

16. Method according to claim 1, characterized in that the water ice particles are produced in the device.
